(19) United States
(12) Patent Application Publication
(10) Pub. No.: US 2024/0405314 A1
(43) Pub. Date: Dec. 5, 2024

(54) Method and Apparatus to Prevent Cell-to-cell Thermal-runaway Propagation

(71) Applicant: American Energy Storage Innovations, Inc., Hudson, MA (US)

(72) Inventors: Scott H. Reitsma, Shrewsbury, MA (US); Bryan Nelson, Clinton, MA (US); Erik Nelson, Upton, MA (US); Frank Rienzo, Mendon, MA (US)

(21) Appl. No.: 18/680,408

(22) Filed: May 31, 2024

Related U.S. Application Data
(60) Provisional application No. 63/505,866, filed on Jun. 2, 2023.

(51) Int. Cl. H01M 10/653; H01M 10/613; H01M 10/6552; H01M 10/658; H01M 50/383

(52) U.S. Cl. CPC H01M 10/653; H01M 10/613; H01M 10/6552; H01M 10/658; H01M 50/383; H01M 2200/10

(57) ABSTRACT

A battery module comprises at least two energy storage cells arranged in a row to form a block of cells. Each energy storage cell has a pair of electrical terminals. The block of cells is arranged such that the electrical terminals are all on a first side of the block of cells. An intumescent insulating sheet is disposed on the first side of the block of cells, and a high-temperature-resistant sheet is disposed on the first side of the block of cells over the intumescent insulating sheet.

### RELATED APPLICATION

This application claims the benefit of U.S. Provisional Application No. 63/505,866, filed on Jun. 2, 2023. The entire teachings of the above application are incorporated herein by reference.

### BACKGROUND

When a lithium-ion cell undergoes thermal-runaway, it emits high temperature, explosive and flammable gasses, exhibits a very high external skin temperature, and sometimes emits flames.

These emissions of heat, hot gasses and sometimes flames can propagate to other cells in the same battery, leading to thermal-runaway in those cells. Thus, left unchecked, the entire battery can undergo thermal-runaway over the course of hours or days, emitting huge volumes of smoke, toxic gasses, fire, and possibly causing collateral damage to people and property nearby.

### SUMMARY

Many battery manufacturers have claimed to have solved this thermal-runaway problem. Some claim they prevent propagation at the cell level, others at the module level, others at the unit level, and even others at the system level.

Some manufacturers realize a solution to the thermal-runaway problem by introducing a cooling medium such as water, or a fire suppressant, while others realize a solution by incorporating enough distance between cells and modules. Others realize a solution by incorporating highly thermally-conductive materials to draw away the heat of the cell.

Muniz patented an idea to combine alternating heat-conduction plates with thermal insulators to isolate the heat from one cell to another. See, e.g., U.S. Pat. No. 8,993,145 B2, “PREVENTING CELL THERMAL RUNAWAY PROPAGATION WITHIN A BATTERY.”

Other materials may have been used to either insulate or conduct heat in and around cells in a battery. Carbon-laced thermally conductive plastics may have been used to surround each cell. Mica sheets may have been placed between cells. Aluminum heatsinks with water channels may have been placed between cells. Intumescent sprays on the inside surfaces of the battery chassis and intumescent balls, like packing material, may have been used to fill the empty spaces around the cells in a battery.

These techniques for addressing thermal-runaway are not always effective, and sometimes bring about undesirable side-effects. For example, the extra spacing reduces the amount of energy that can be stored in a given volume. Highly conductive heat sinks are heavy and costly to manufacture. Water introduced in the battery can sometimes inadvertently cause fires from undetected leaks or accidental discharges.

In the example embodiments described herein, multiple layers of insulating materials are arranged in a way that reduces the heat transfer and flow of fire from one or more cells undergoing thermal-runaway. Cells are closely spaced in a battery. Thermal insulation is placed between those cells, and an intumescent sheet is placed on top of cells. A high-temperature flexible sheet is placed on top of intumescent sheet. Patterns are cut in the flexible sheets to allow excessive gas flow out of thermally-active cells, but not allow flammable gasses to contact the cells that are not thermally active. The cells are mounted on a liquid-cooled heatsink.

The described embodiments reduce the flow of heat, hot gasses, and fire from the hot cell(s) to a point that is under the threshold that would trigger thermal-runaway in the other nearby cells. The materials used in the described embodiments also serve as an electrically insulative medium, preventing bus bars from inadvertently shorting between the conductive aluminum cell case and the terminals during the manufacturing process.

The multiple layers of insulating materials are cost-effective, lightweight, and do not increase the battery's weight and volume over that which was necessary for a physically robust battery design. The materials can be installed quickly and do not emit harmful emissions during thermal events. The described embodiments avoid introducing a potential for water damage or chemical hazards associated with traditional fire suppression. The disclosed embodiments are passive and do not require automatic electronic or mechanical systems for activation.

In one aspect, the invention may be a battery module, comprising at least two energy storage cells arranged in a row to form a block of cells. Each energy storage cell may have a pair of electrical terminals, and the block of cells may be arranged such that the electrical terminals are all on a first side of the block of cells. An intumescent insulating sheet may be disposed on the first side of the block of cells, and a high-temperature-resistant sheet may be disposed on the first side of the block of cells over the intumescent insulating sheet.

The intumescent insulating sheet and the high-temperature-resistant sheet may each have apertures configured to facilitate access to the pairs of electrical terminals. Each pair of adjacent cells of the block of cells may be separated by a temperature-insulating pad. The temperature-insulating pad may be fabricated of a material that is sufficiently compressible to accommodate the expected expansion of the energy storage cell over a service life of the energy storage cells.

The intumescent insulating sheet and the high-temperature-resistant sheet may each have an aperture to facilitate gas escaping from the energy storage cells. Each cell of the block of cells may be in thermal contact with a heatsink. The intumescent insulating sheet may be draped over the energy storage cells. The intumescent insulating sheet may be fabricated from an inflexible material molded to fit onto the first side of the block of cells. The high-temperature-resistant sheet may be draped over the intumescent insulating sheet. The high-temperature-resistant sheet may be fabricated from an inflexible material molded to fit over the intumescent insulating sheet. The high-temperature-resistant sheet may comprise silicone.

In another aspect, the invention may be a method of mitigating a thermal-runaway condition in a battery of energy storage cells that comprises disposing an intumescent insulating sheet on a first side of the block of cells and disposing a high-temperature-resistant sheet on the first side of the block of cells over the intumescent insulating sheet.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 shows another example supercell module with an intumescent insulating sheet and a high-temperature silicone sheet.

FIG. 2 shows a more detailed view of the supercell module of FIG. 1.

FIG. 3 shows the example supercell module with the intumescent insulating sheet and a high-temperature silicone sheet installed.

FIG. 4A shows a top view of a portion of the example supercell module.

FIG. 4B shows a side view of a portion of the supercell module.

FIG. 4C shows another side view of the supercell module with a cutaway revealing a cell resting on a heatsink.

### DETAILED DESCRIPTION

A description of example embodiments follows.

A group of cells is placed in close proximity to each other in a battery. They are separated by an insulating pad that can withstand 500° C. without significantly deteriorating or catching fire. The insulation prevents the conduction of most of the heat from a cell undergoing thermal-runaway to its neighboring cells.

A sheet of intumescent material is draped over the battery cells. The intumescent material undergoes a structural phase change in the presence of temperatures between 250C and 500C, whereupon it expands to fully fill the space in which it is kept. Its expanded form is a fibrous, fluffy, and highly insulative. In this application, it controls the temperature rise in neighboring cells resulting from the fire that may occur at one cell in the battery system. An example of a suitable intumescent material may include, but is not limited to, the 3M™ “Firestop” sheet.

A flexible, high-temperature-resistant sheet is draped over the intumescent insulating sheet. The flexible sheet is specified to withstand temperatures up to that which is expected during a thermal-runaway event. After the intumescent insulating sheet transforms to a fibrous, loose material, the flexible sheet contains the intumescent insulating material around the protected cells, increasing the effectivity of the intumescent material.

The flexible, high-temperature-resistant sheet is intentionally perforated near the cell vents or source of emitting gasses so that the burst of gasses coming from the cell does not irreversibly remove the flexible sheet from the area which needs to be protected. The partial perforations allow the other cells not in thermal runaway to be protected by the intact flexible sheet and underlying intumescent insulating material.

The insulating pads between the cells can be specified to compress a certain amount corresponding to the expected expansion of the cells during their service life. Examples of suitable insulating pads include, but are not limited to, Bisco® “HT-870” or National Silicone™ “NS-120”.

The intumescent insulating sheet may be a custom-molded solid piece that fits over the cells instead of draping and folding over them. The flexible high-temperature-resistant sheet can be made with silicone or other non-conductive material that is tolerant to the expected temperatures. The high-temperature-resistant sheet can be a custom-molded solid piece that is designed to fit over the intumescent insulating sheet without having to bend and fold the intumescent insulating sheet to conform to the battery's shape. The intumescent insulating and high-temperature-resistant sheets can be molded together forming one unified semi-solid piece that fits easily over the top of the battery cells, reducing the number of assembly steps.

In addition, the cells are placed on a liquid-cooled heatsink which removes a portion of heat being generated in the cell undergoing thermal-runaway. The liquid in the heatsink is constantly flowing, thus maintaining the heatsink under the cells at a substantially, constant temperature. This prevents heat from being transferred from one cell to another through the heatsink and reduces the temperature of the initiating cell.

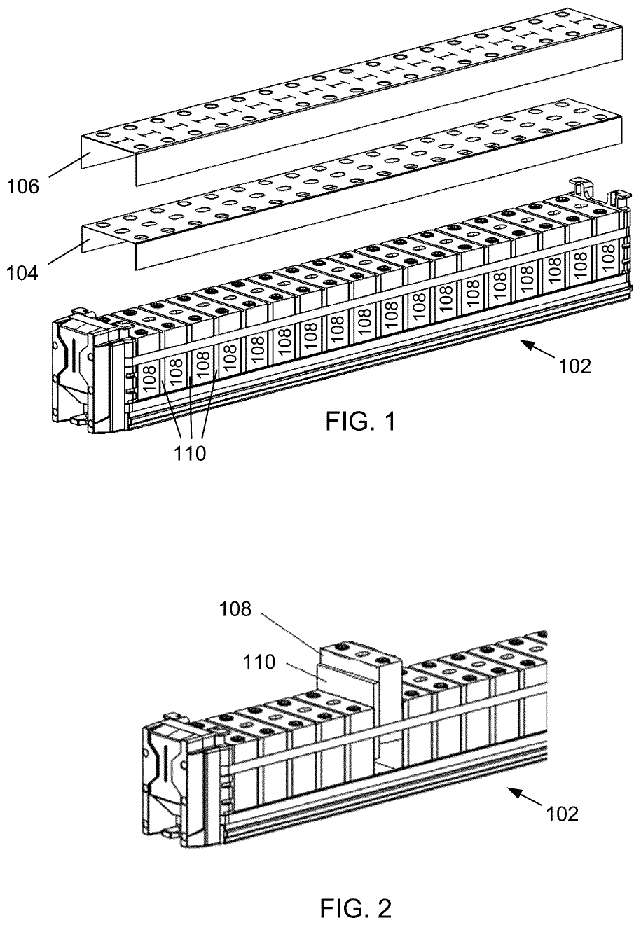

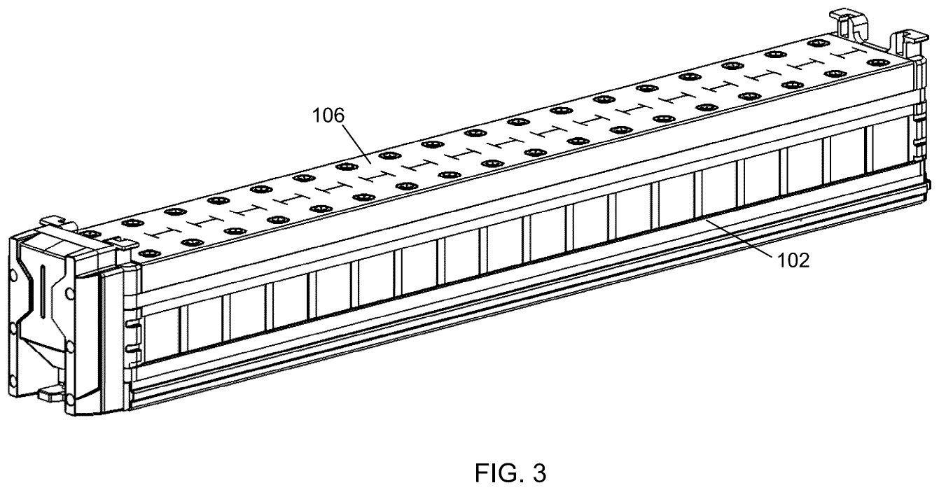

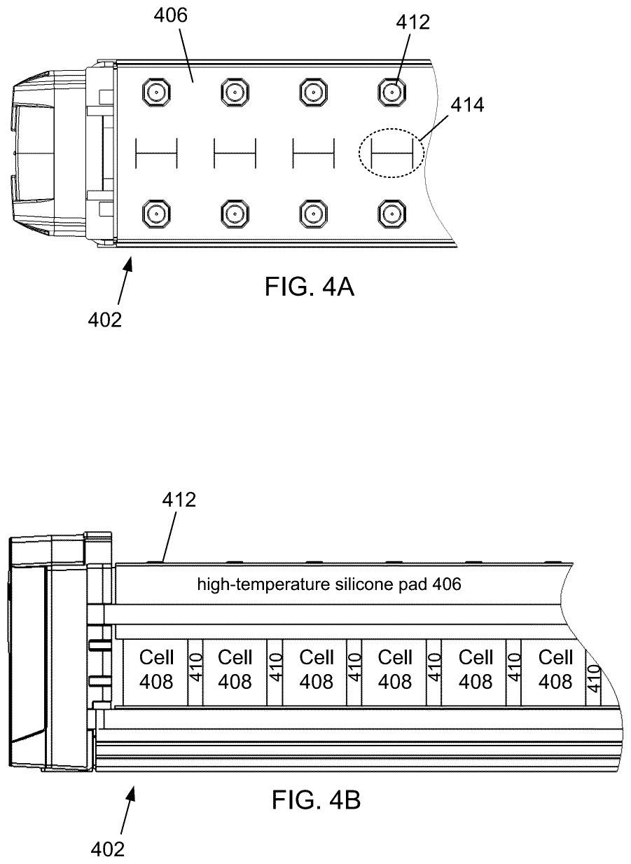

FIG. 1 shows an example 18-cell supercell module 102 with an intumescent insulating sheet 104 and a high-temperature-resistant sheet 106 shown apart from the supercell module 102. FIG. 2 shows one of the cells 108 partially removed from the supercell module 102 and shows one of the insulating pads 110 that separates adjacent cells. FIG. 3 shows the 18-cell supercell module 102 with the intumescent insulating sheet 104 and the high-temperature-resistant sheet 106 installed. In an embodiment, the intumescent insulating sheet 104 may be fabricated from flat sheet stock using a die cut process (similar to labels). The intumescent insulating sheet 104 counters thermal propagation and provides electrical insulation between current-carrying busbars and cell cans. The high-temperature-resistant sheet 106 may be fabricated from flat sheet/roll stock using a die cut process (similar to labels). The high-temperature-resistant sheet 106 prevents heat exposure from a venting cell and provides additional electrical insulation between current-carrying busbars and cell cans.

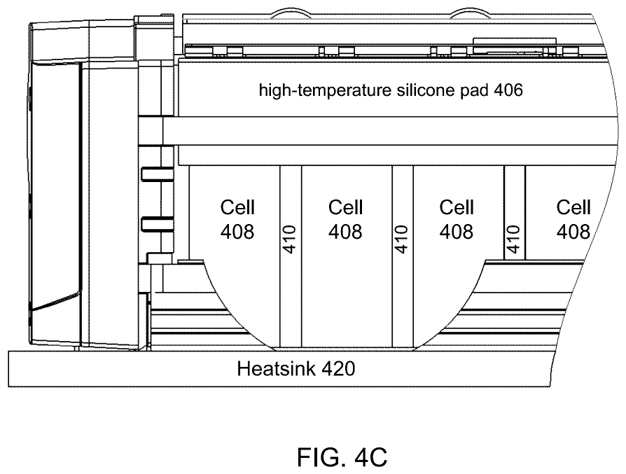

FIG. 4A shows a top view of a portion of an example supercell module 402. One of the cell terminals 412 is shown protruding through the high-temperature-resistant sheet 406, along with one of the slits 414 cut into the high-temperature-resistant sheet to allow gasses to escape from the cells. A slit 414 is provided for each cell in this example. FIG. 4B shows a side view of a portion of the supercell module 402, showing the cells 408 and the insulating pads 410. FIG. 4C shows another side view of the supercell module 402 with a cutaway revealing a cell 408 resting on a heatsink 420. Heat dissipated by the cells may be absorbed and conveyed away from the cells by the heat sink 420.

While example embodiments have been particularly shown and described, it will be understood by those skilled in the art that various changes in form and details may be made therein.

What is claimed is:

1. A battery module, comprising:
at least two energy storage cells arranged in a row to form a block of cells, each energy storage cell having a pair of electrical terminals, the block of cells arranged such that the electrical terminals are all on a first side of the block of cells;
an intumescent insulating sheet disposed on the first side of the block of cells; and
a high-temperature-resistant sheet disposed on the first side of the block of cells over the intumescent insulating sheet.

2. The battery module of claim 1, wherein the intumescent insulating pad and the high-temperature-resistant sheet each has apertures configured to facilitate access to the pairs of electrical terminals.

3. The battery module of claim 1, wherein each pair of adjacent cells of the block of cells is separated by a temperature-insulating pad.

4. The battery module of claim 3, wherein the temperature-insulating pad is fabricated of a material that is sufficiently compressible to accommodate expansion of the energy storage cell over a service life of the energy storage cell.

5. The battery module of claim 1, wherein the intumescent insulating sheet and the high-temperature-resistant sheet each has an aperture to facilitate gas escaping from the energy storage cells.

6. The battery module of claim 1, wherein each cell of the block of cells is in thermal contact with a heatsink.

7. The battery module of claim 1, wherein the intumescent insulating sheet is draped over the energy storage cells.

8. The battery module of claim 1, wherein the intumescent insulating sheet is fabricated from an inflexible material molded to fit onto the first side of the block of cells.

9. The battery module of claim 1, wherein the high-temperature-resistant sheet is draped over the intumescent insulating sheet.

10. The battery module of claim 1, wherein the high-temperature-resistant sheet is fabricated from an inflexible material molded to fit over the intumescent insulating sheet.

11. The battery module of claim 1, wherein the high-temperature-resistant sheet comprises silicone.

12. A method of mitigating a thermal-runaway condition in a battery of energy storage cells, comprising:
disposing an intumescent insulating sheet on a first side of the block of cells; and
disposing a high-temperature-resistant sheet on the first side of the block of cells over the intumescent insulating sheet.

13. The method of claim 12, further comprising incorporating apertures in the intumescent insulating sheet and the high-temperature-resistant sheet configured to facilitate access to the pairs of electrical terminals.

14. The method of claim 12, further comprising separating each pair of adjacent energy storage cells of the block of cells by a temperature-insulating pad.

15. The method of claim 12, wherein the temperature-insulating pad is fabricated of a material that is sufficiently compressible to accommodate expansion of the energy storage cell over a service life of the energy storage cell.

16. The method of claim 12, further comprising providing an aperture in each of the intumescent insulating sheet and the high-temperature-resistant sheet to facilitate gas escaping from the energy storage cells.

17. The method of claim 12, further comprising thermally coupling each cell of the block of cells to a heatsink.

18. The method of claim 12, further comprising draping the intumescent insulating sheet over the energy storage cells.

19. The method of claim 12, further comprising fabricating the intumescent insulating sheet from an inflexible material molded to fit onto the first side of the block of cells.

20. The method of claim 12, further comprising draping the high-temperature-resistant sheet over the intumescent insulating sheet.

21. The method of claim 12, further comprising fabricating the high-temperature-resistant sheet from an inflexible material molded to fit over the intumescent insulating sheet.
